(19) United States
(12) Patent Application Publication
(10) Pub. No.: US 2026/0102861 A1
(43) Pub. Date: Apr. 16, 2026

(54) PRODUCTION PROCESS FOR WINDING AND WEAVING DECORATIVE LAMP BASED ON SPRING-LIKE METAL STRIP

(71) Applicant: TAIZHOU GONGCHUANG LIGHTING CO., LTD., Taizhou (CN)

(72) Inventor: Pingping LIU, Taizhou (CN)

(73) Assignee: TAIZHOU GONGCHUANG LIGHTING CO., LTD., Taizhou (CN)

(21) Appl. No.: 18/915,120

(22) Filed: Oct. 14, 2024

(51) Int. Cl. B23P 23/04; B21C 23/00; B21C 23/08; B23P 15/00; B23P 19/04

(52) U.S. Cl. CPC B23P 23/04; B23P 15/00; B21C 23/005

(57) ABSTRACT

The present disclosure discloses a production process for winding and weaving a decorative lamp based on a string-like metal strip, and a decorative lamp, and aims to provide a production process for winding and weaving a decorative lamp based on a string-like metal strip, achieving high structural stability and long service life. A key pint of the technical solution of the present disclosure is that the metal strip cooperates with a three-dimensional architecture or a planar architecture, so that there is a fixed direction provided for interlaced winding of the metal strip to form a corresponding shape based on the three-dimensional architecture or the planar architecture, thereby improving the overall stability.

After a light string is wound around the metal strips, an exposed structural arrangement can make the wound three-dimensional architecture or planar architecture more tridimensional. The present disclosure is applicable to the technical field of decorative lamps.

### BACKGROUND

### 1. Technical Field Text

The present disclosure relates to the technical field of decorative lamps, and in particular, to a production process for winding and weaving a decorative lamp based on a spring-like metal strip, and a decorative lamp.

### 2. Background Information

Light-emitting diodes are widely used in the lighting industry due to their advantages of energy conservation, power saving, high efficiency, fast response, long lifespan, zero mercury, environmental friendliness, and the like.

A light string, also referred to as a polyvinyl chloride (PVC) flexible wire light string, includes a lead wire, a rubber-covered wire wrapped around the lead wire, and a chip that is arranged inside the rubber-covered wire and is connected to the lead wire. A lamp holder, such as a light-emitting diode (LED) light bead, is integrated on the chip. During the production, a rubber-covered wire tape (including a lead wire and a cover wrapped around the lead wire) is usually pre-formed or purchased, and then, a chip integrated with a lamp holder is encapsulated onto the wire tape structure.

At present, for a decorative lamp on the market, after mold opening is performed on a fixed plastic shell, a light string is generally mounted on the plastic shell. However, the shell made of this material cannot guarantee stable use for a long time. Furthermore, a use environment is particularly important. Especially, an outdoor environment will accelerate the aging of the shell and affect the service life of the shell.

### BRIEF SUMMARY

For the shortcomings in the prior art, the present disclosure aims to provide a production process for winding and weaving a decorative lamp based on a spring-like metal strip, achieving high structural stability and long service life.

To achieve the above objective, the present disclosure provides the following technical solution: A production process for winding and weaving a decorative lamp based on a string-like metal strip is a process of making several metal strips into several spring-like basic parts, then connecting the spring-like basic parts in a winding connection way to form different shapes, and finally winding a light string. The production process specifically includes the following steps:

S1, preparing materials: preparing a cutting tool and several metal strips, cutting the metal strips into different lengths according to three-dimensional architectures or planar architectures of decorative parts in different shapes, and winding up the cut metal strips through a winding machine to form spring-like metal strips for later use;

S2, after the above spring-like basic parts are prepared, connecting the spring-like basic parts in the winding connection way to form different shapes, which includes the following ways:
interlacing single basic parts in sequence: stretching the basic parts towards two ends, plugging the basic parts into corresponding gaps, and threading at least one basic part between interlaced end portions of the basic parts;
winding and interlacing two basic parts: stretching the basic parts towards two ends, spinning and winding one basic part from an end portion of the basic part on the other basic part, and threading at least one basic part between interlaced end portions of the basic parts;

S3, using the three-dimensional architectures or planar architectures in different shapes as basic architectures, and deforming and connecting the above basic parts according to the interlacing and winding ways in step S2 to make basic decorative parts, or winding up the basic parts to form spherical decorative parts, without depending on the three-dimensional architectures or planar architectures; and

S4, uniformly winding a light string with the formed basic decorative parts to form the decorative lamp.

In a further setting of the present disclosure: each metal strip can be a hollow round-tube spring-like long strip made of one or several of copper, iron, aluminum, and tin.

In a further setting of the present disclosure: the basic parts are hollow metal strips that are formed by cutting the metal strips and performing continuous hollow extrusion, and the hollow metal strips are wound up to form the spring-like metal strips through the winding machine.

In a further setting of the present disclosure: when connectors for interlacing the basic parts are used to thread one metal strip, a half-folding angle between the connected basic parts is 0-180°; and when the connectors for interlacing the basic parts are used to thread two or more metal strips, a half-folding angle between the connected basic parts is 130-180°.

In a further setting of the present disclosure: when connectors for interlacing the basic parts are used to thread one metal strip, an end portion of the metal strip is rolled up to be spiral and drives the basic parts to bend into arc-shaped basic parts; and deformation molding is performed on exteriors of the arc-shaped basic parts.

In a further setting of the present disclosure: connectors for interlacing the basic parts adjust diameters of the basic parts; the diameter of a middle basic part is greater than the diameter of a peripheral basic part; end portions at joints of the basic parts are plugged into linkage parts for fixing and sizing; inwards recessed indentations are provided on the basic parts; and the inwards recessed indentations resist against outer walls of the linkage parts.

In a further setting of the present disclosure: several connectors used for winding and interlacing the basic parts are connected for molding; the end portions of the basic parts are supported using the metal strips plugged into middle positions of connected portions of the basic parts; and the basic parts are sized in an axial direction through the bent and plugged metal strips.

A decorative lamp produced by the production process for winding and weaving a decorative lamp based on a string-like metal strip described above includes three-dimensional architectures or planar architectures in different shapes, which are used as basic architectures, and metal strips that are interlaced and wound around the three-dimensional architectures or planar architectures, wherein the metal strips are spring-like; the metal strips use the three-dimensional architectures or the planar architectures as the basic architectures and are wound up to form decorative parts in different shapes; and a light string is wound around the decorative parts.

In a further setting of the present disclosure: carve patterns are uniformly distributed on outer walls of the metal strips.

In a further setting of the present disclosure: each metal strip is a hollow round-tube spring-like long strip made of one or several of copper, iron, aluminum, and tin.

By use of the above technical solution, the present disclosure has the following beneficial effects: The metal strip cooperates with a three-dimensional architecture or a planar architecture, so that there is a fixed direction provided for interlaced winding of the metal strip to form a corresponding shape based on the three-dimensional architecture or the planar architecture, thereby improving the overall stability. After a light string is wound around the metal strips, an exposed structural arrangement can make the wound three-dimensional architecture or planar architecture more tridimensional; in a lighting state, the effect is better; and in addition, a metal material, especially an aluminum material, achieves longer service life and better stability.

### BRIEF DESCRIPTION OF THE DRAWINGS

FIG. 1 is a schematic structural diagram of a spherical finished product of an embodiment of a production process for winding and weaving a decorative lamp based on a string-like metal strip according to the present disclosure.

FIG. 2 is a partially schematic structural diagram of a pentacle-shaped finished product of an embodiment of a production process for winding and weaving a decorative lamp based on a string-like metal strip according to the present disclosure.

FIG. 3 is a schematic structural diagram of a basic part and a linkage part of an embodiment of a production process for winding and weaving a decorative lamp based on a string-like metal strip according to the present disclosure.

Numerals in the drawings: 1: metal strip; 2: basic part; 20: linkage part; 21: inwards recessed indentation; 3: basic architecture; 4: basic decorative part; and 5: light string.

### DETAILED DESCRIPTION OF THE DRAWINGS AND THE PRESENTLY PREFERRED EMBODIMENTS

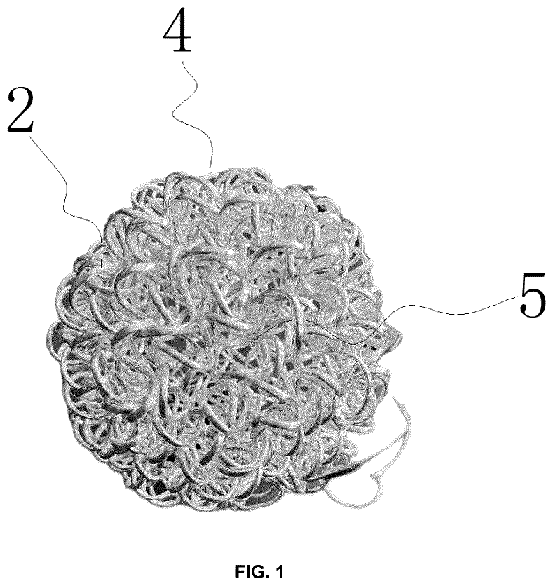

Referring to FIG. 1 to FIG. 3, an embodiment of a production process for winding and weaving a decorative lamp based on a string-like metal strip according to the present disclosure is further explained.

For ease of explanation, spatial relative terms such as “up”, “down”, “left”, and “right” are used in the embodiments to illustrate a relationship between one element or feature shown in the figures and another element or feature. It should be understood that in addition to the orientations shown in the figures, the spatial terms are intended to include different orientations of a device during use or operation. For example, if the device in the figures is placed upside down, an element described as being located “below” another element or feature will be positioned as being “above” the another element or feature. Therefore, the exemplary term “down” can include both up and down orientations. The device can be positioned in other ways (rotated 90 degrees or in other orientations), and the spatial relative explanations used here can be explained correspondingly.

Moreover, relational terms such as “first” and “second” are only used to distinguish one component from another with the same name, without necessarily requiring or implying any actual relationship or order between these components.

A production process for winding and weaving a decorative lamp based on a string-like metal strip is a process of making several metal strips into several spring-like basic parts, then connecting the spring-like basic parts in a winding connection way to form different shapes, and finally winding a light string; and the production process specifically includes the following steps:

S1, preparing materials: preparing a cutting tool and several metal strips, cutting the metal strips into different lengths according to three-dimensional architectures or planar architectures of decorative parts in different shapes, and winding up the cut metal strips through a winding machine to form spring-like metal strips for later use;

S2, after the above spring-like basic parts are prepared, connecting the spring-like basic parts in the winding connection way to form different shapes, which includes the following ways:
interlacing single basic parts in sequence: stretching the basic parts towards two ends, plugging the basic parts into corresponding gaps, and threading at least one basic part between interlaced end portions of the basic parts;
winding and interlacing two basic parts: stretching the basic parts towards two ends, spinning and winding one basic part from an end portion of the basic part on the other basic part, and threading at least one basic part between interlaced end portions of the basic parts;

S3, using the three-dimensional architectures or planar architectures in different shapes as basic architectures, and deforming and connecting the above basic parts according to the interlacing and winding ways in step S2 to make basic decorative parts, or winding up the basic parts to form spherical decorative parts, without depending on the three-dimensional architectures or planar architectures; and

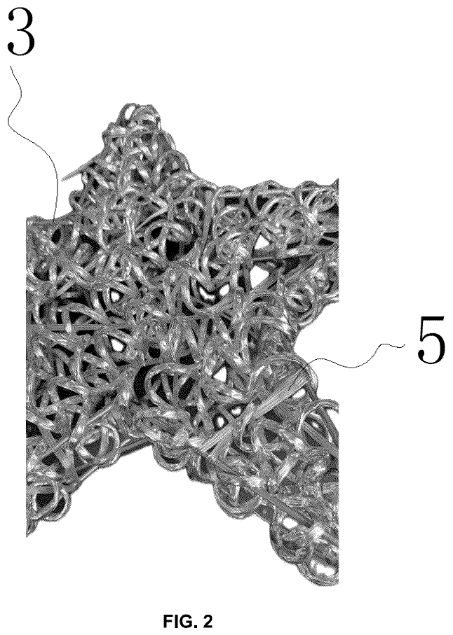

As shown in FIG. 1 and FIG. 2, since the basic parts are irregularly wound, they are presented in the form of black-and-white pictures. As shown in FIG. 2, if basic architectures exist, the basic architectures can be used as carriers for winding. The structure shown in FIG. 1 does not require a basic architecture, and can be gradually wound by the basic parts to form a spherical structure.

S4, uniformly winding a light string with the formed basic decorative parts to form the decorative lamp.

The three-dimensional architectures or planar architectures are used as basic architectures, and the light string is wound based on this. The winding way is interlacing single basic parts in sequence and winding and interlacing two basic parts, which makes the basic architectures more tridimensional. This enhances the molding effect and stability. Furthermore, the light string is wound to form the decorative lamp, so that the molding effect is good, and the practicabiliy is high.

In a further setting of the present disclosure, each metal strip can be a hollow round-tube spring-like long strip made of one or several of copper, iron, aluminum, and tin.

In a further setting of the present disclosure, the basic parts are hollow metal strips that are formed by cutting the metal strips and performing continuous hollow extrusion, and the hollow metal strips are wound up to form the spring-like metal strips through the winding machine.

In a further setting of the present disclosure, when connectors for interlacing the basic parts are used to thread one metal strip, a half-folding angle between the connected basic parts is 0-180°; and when the connectors for interlacing the basic parts are used to thread two or more metal strips, a half-folding angle between the connected basic parts is 130-180°.

In a further setting of the present disclosure, when connectors for interlacing the basic parts are used to thread one metal strip, an end portion of the metal strip is rolled up to be spiral and drives the basic parts to bend into arc-shaped basic parts; and deformation molding is performed on exteriors of the arc-shaped basic parts.

In a further setting of the present disclosure, connectors for interlacing the basic parts adjust diameters of the basic parts; the diameter of a middle basic part is greater than the diameter of a peripheral basic part; end portions at joints of the basic parts are plugged into linkage parts for fixing and sizing; inwards recessed indentations are provided on the basic parts; and the inwards recessed indentations resist against outer walls of the linkage parts.

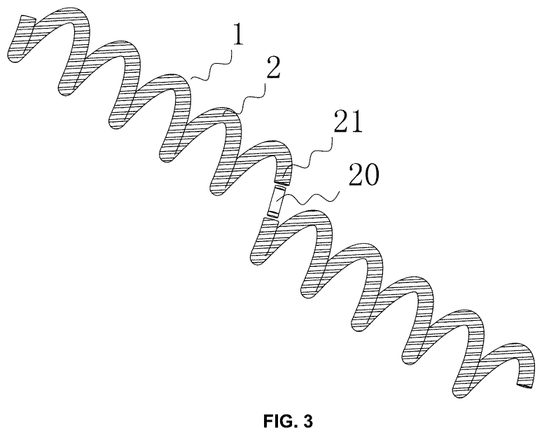

As shown in FIG. 3, in this embodiment of the present disclosure, if it is found that the various basic parts are not connected, the end portions at the joints of the basic parts are plugged into the linkage parts for fixing and sizing; the inwards recessed indentations are provided on the basic parts; and the inwards recessed indentations resist against the outer walls of the linkage parts, thereby improving the strength of a connected structure between them and achieving high stability and high practicability. Great friction is formed between the inwards recessed indentations and the outer walls of the linkage parts to achieve the bonding strength between the inwards recessed indentations and the outer walls of the linkage parts.

In a further setting of the present disclosure, several connectors for winding and interlacing the basic parts are connected for molding; the end portions of the basic parts are supported using the metal strips plugged into middle positions of connected portions of the basic parts; and the basic parts are sized in an axial direction through the bent and plugged metal strips.

A decorative lamp produced by the production process for winding and weaving a decorative lamp based on a string-like metal strip described above includes three-dimensional architectures or planar architectures in different shapes, which are used as basic architectures, and metal strips that are interlaced and wound around the three-dimensional architectures or planar architectures, wherein the metal strips are spring-like; the metal strips use the three-dimensional architectures or the planar architectures as the basic architectures and are wound up to form decorative parts in different shapes; and a light string is wound around the decorative parts.

In a further setting of the present disclosure, carve patterns are uniformly distributed on outer walls of the metal strips.

In a further setting of the present disclosure, each metal strip is a hollow round-tube spring-like long strip made of one or several of copper, iron, aluminum, and tin.

By use of the above technical solution, the present disclosure has the following beneficial effects: The metal strip cooperates with a three-dimensional architecture or a planar architecture, so that there is a fixed direction provided for interlaced winding of the metal strip to form a corresponding shape based on the three-dimensional architecture or the planar architecture, thereby improving the overall stability. After a light string is wound around the metal strips, an exposed structural arrangement can make the wound three-dimensional architecture or planar architecture more tridimensional; in a lighting state, the effect is better; and in addition, a metal material, especially an aluminum material, achieves longer service life and better stability.

The above-mentioned embodiments are only preferred embodiments of the present disclosure and are not intended to limit the present disclosure, and the usual changes and substitutions made by those skilled in the art within the scopes of the technical solutions of the present disclosure shall fall within the protection scope of the present disclosure.

What is claimed is:

1. A production process for winding and weaving a decorative lamp based on a metal strip, wherein the production process is a process of making several metal strips into several spiral basic parts, then connecting the spiral basic parts to form different shapes, and finally winding a light string; and the production process specifically comprises the following steps:
S1, preparing materials: preparing a cutting tool and several metal strips, cutting the metal strips into different lengths according to three-dimensional architectures or planar architectures in different shapes, and winding up the cut metal strips through a winding machine to form spiral metal strips;
S2, after the spiral basic parts are prepared, connecting the spiral basic parts to form different shapes, which comprises two different ways as following:
a first way: stretching the spiral basic parts towards two ends, leaving predetermined gaps between every two of the spiral basic parts, and threading at least one spiral basic part between interlaced end portions of the basic parts;
second way: stretching the basic parts towards two ends, spinning one basic part of the basic parts from an end portion of the basic part and winding the basic part on another basic part, and threading at least one basic part between interlaced end portions of the basic parts;
S3, using the three-dimensional architectures or planar architectures in different shapes as basic architectures, and deforming and connecting the basic parts according to the interlacing and winding ways in step S2 to make basic decorative parts; and
S4, uniformly winding a light string with the formed basic decorative parts to form the decorative lamp.

2. The production process for winding and weaving the decorative lamp based on the metal strip according to claim 1, wherein each metal strip is a made of one or several of copper, iron, aluminum, and tin.

3. The production process for winding and weaving the decorative lamp based on the metal strip according to claim 1, wherein the basic parts are formed by cutting the metal strips and performing continuous hollow extrusion, and the hollow metal strips are wound up to form the spiral metal strips through the winding machine.

4. The production process for winding and weaving the decorative lamp based on the metal strip according to claim 1, wherein when connectors for interlacing the basic parts are used to thread one metal strip, a half-folding angle between connected basic parts is 0-180°; and when the connectors for interlacing the basic parts are used to thread two or more metal strips, a half-folding angle between the connected basic parts is 130-180°.

5. The production process for winding and weaving the decorative lamp based on the metal strip according to claim 1, wherein when connectors for interlacing the basic parts are used to thread one metal strip, an end portion of the metal strip is rolled up to be spiral and drives the basic parts to bend into arc-shaped basic parts; and
deformation molding is performed on exteriors of the arc-shaped basic parts.

6. The production process for winding and weaving the decorative lamp based on the metal strip according to claim 1, wherein connectors for interlacing the basic parts adjust diameters of the basic parts; the diameter of a middle basic part is greater than the diameter of a peripheral basic part; end portions at joints of the basic parts are plugged into linkage parts for fixing and sizing; inwards recessed indentations are provided on the basic parts; and the inwards recessed indentations resist against outer walls of the linkage parts.

7. The production process for winding and weaving the decorative lamp based on the metal strip according to claim 1, wherein several connectors used for winding and interlacing the basic parts are connected for molding; the end portions of the basic parts are supported using the metal strips plugged into middle positions of connected portions of the basic parts; and the basic parts are sized in an axial direction through bent and plugged metal strips.

8. A decorative lamp produced by the production process for winding and weaving a decorative lamp based on a string-like metal strip according to claim 1, comprising three-dimensional architectures or planar architectures in different shapes, which are used as basic architectures, and metal strips that are interlaced and wound around the three-dimensional architectures or planar architectures, wherein the metal strips are spring-like; the metal strips use the three-dimensional architectures as the basic architectures and are wound up to form decorative parts in different shapes; and a light string is wound around the decorative parts.

9. The production process for winding and weaving the decorative lamp based on the string-like metal strip according to claim 8, wherein carve patterns are uniformly distributed on outer walls of the metal strips.

10. The production process for winding and weaving the decorative lamp based on the string-like metal strip according to claim 9, wherein each metal strip is a hollow round-tube spring-like long strip made of one or several of copper, iron, aluminum, and tin.
